(19) United States
(12) Patent Application Publication
(10) Pub. No.: US 2012/0142315 A1
(43) Pub. Date: Jun. 7, 2012

(54) METHOD FOR AUTHENTICATION AND KEY ESTABLISHMENT IN A MOBILE COMMUNICATION SYSTEM AND METHOD OF OPERATING A MOBILE STATION AND A VISITOR LOCATION REGISTER

(76) Inventors: Jong-Moon CHUNG, Seoul (KR); Hyun-Jue Kim, Seoul (KR)

(21) Appl. No.: 12/960,827

(22) Filed: Dec. 6, 2010

(51) Int. Cl. H04W 8/06; H04W 12/06; H04W 12/04

(52) U.S. Cl. 455/411

(57) ABSTRACT

The present invention relates to a method whereby the mobile station and a visitor location register create and share a ciphering key and an integrity key in order to directly authenticate each other. The communication method in a mobile communication system such as this includes registering the mobile station with the home location register; and having the mobile station and the visitor location register directly authenticate each other and mutually share a ciphering key and an integrity when the mobile station moves to the visitor location register.

### TECHNICAL FIELD

The present invention relates to a communication method in a mobile communication system, more particularly to a method of creating and sharing a ciphering key and an integrity key while a mobile station and a visitor location register directly authenticate each other.

### BACKGROUND ART

In a mobile communication system, a mobile station and a visitor location register execute a process by which they mutually share a ciphering key and an integrity key in order to verify the authentication process, encoding/decoding, and integrity, and execute mutual communication by using the ciphering key and the integrity key.

Below, a conventional method of authenticating and sharing the ciphering key and the integrity key will be described with reference to the appended illustrations.

FIG. 1 is a drawing illustrating a general mobile communication system, and FIG. 2 is a flowchart illustrating processes of authentication and sharing the ciphering key and integrity key according to the related art.

With reference to FIG. 1, the mobile communication system, especially the 3GPP system may consist of a mobile station (MS) 100, a home location register (HLR) 102, and visitor location registers (VLRs) 104 and 106.

In such a mobile communication system, the mobile station 100, in the earliest phase, registers with the home location register 102 in order to be provided with mobile communication service. In this case, the home location register 102 creates a shared key, which is shared with the mobile station 100, and the international mobile subscriber identity data (IMSI), the temporary mobile subscriber identity data (TMSI), and sequence number (SQN) of the mobile station 100, and stores them in the universal subscriber identity module (USIM) of the mobile station 100. Here, the temporary mobile subscriber identity is temporary data created by the home location register 102 or visitor location register 104 or 106, for use only within the corresponding jurisdiction after the register 102, 104 or 106 authenticates the mobile station 100 that has moved into its jurisdiction.

Each of the visitor location registers 104, 106 is a register that executes the managing role when service for its area is requested by the mobile station 100 of another area, and enables the mobile station 100 to receive roaming service freely.

For such roaming service, the mobile station 100 has to register with the visitor location register 104 or 106 for receiving service, and as part of the registration process, the authentication and key establishment process are executed.

Below, the conventional authentication and key establishment process will be examined. However, for the sake of ease of explanation, it is assumed that the mobile station 100 has moved from the jurisdiction of a first visitor location register 104 to that of a second visitor location register 106.

With reference to FIG. 2, if the mobile station 100 moves into the jurisdiction of the second visitor location register 106, the mobile station 100 transmits the registration request message to the second visitor location register 106 (operation S200).

Next, the second visitor location register 106, in response to the registration request message, transmits the mobile station information request message to the mobile station 100 (operation S202).

Subsequently, the mobile station 100, in response to the mobile station request message, transmits the mobile station information, such as the location area identity data (LAIo) for the jurisdiction of the previous visitor location register 104 and the temporary mobile subscriber identity data (TMSIo) of the mobile station 100, to the second visitor location register 106 (operation S204).

Next, the second visitor location register 106 requests the first visitor location register 104 for the identity information of the mobile station 100 for the temporary mobile subscriber identity data (TMSIo) (operation S206).

Subsequently, the first visitor location register 104, in response to the request for the identity information, transmits the international mobile subscriber identity data (IMSI) of the mobile station 100 to the second visitor location register 106 (operation S208).

Next, the second visitor location register 106 transmits the authentication data request message for the international mobile subscriber identity data (IMSI) to the home location register 102 (operation S210).

Subsequently, the home location register 102, in response to the authentication data request message, creates an “n” number of authentication vectors (AV(1, . . . , n)) for the international mobile subscriber identity data (IMSI) as in Formula 1 below, and transmits the authentication vectors thus created to the second visitor location register 106 (operation S212).

AV=RAND∥XRES∥CK∥IK∥AUTH [Formula 1]

Each authentication vector consists of a random number (RAND), an expected response (XRES) created by the use of a shared key (K) shared with the mobile station 100, a ciphering key (CK), an integrity key (IK), and an authentication token (AUTN). The expected response (XRES) is used by the second visitor location register 106 to authenticate the mobile station 100, and the authentication token (AUTN) is used by the mobile station 100 to authenticate the home location register 102.

XRES=ƒ2ₖ(RAND)

CK=ƒ3ₖ(RAND)

IK=ƒ4ₖ(RAND)

AUTN=SQN⊕AK∥AMF∥MAC

AK=ƒ5ₖ(RAND)

MAC=ƒ1ₖ(SQN∥RAND∥AMF) [Formula 2]

Here, f2 signifies a message authentication function, f3 and f4 represent key creation functions, and AMF signifies an authentication management field.

Next, the second visitor location register 106 selects one authentication vector out of the authentication vectors above, and then transmits RAND and AUTN to the mobile station 100, requesting authentication of the mobile station (operation S214).

Subsequently, the mobile station 100 uses the shared key (K) shared with the home location register 102 to compute AK and SQN as in Formula 3 below, checking whether the sequence number (SQN) has the accurate value, and computes XMAC, comparing it with the transmitted MAC.

AK=ƒ5ₖ(RAND)

SQN=(SQN⊕AK)⊕AK)

XMAC=ƒ1ₖ(SQN∥RAND∥AMF) [Formula 3]

Here, f1 is a message authentication function, and f5 is a key creation function.

Next, the mobile station 100 checks MAC and SQN, and if the values are accurate, determines that the home location register 102 has been authenticated, in which case it transmits a response RES as in Formula 4 to the second visitor location register 106 (operation S216).

RES=ƒ2ₖ(RAND) [Formula 4]

Subsequently, the second visitor location register 106, if XRES and RES are equal, determines that the mobile station 100 has been authenticated, in which case it transmits a new temporary mobile subscriber identity data (TMSIn) to the mobile station 100, completing the mobile station authentication (operation S218).

Next, the mobile station 100 computes the ciphering key (CK) and the integrity key (IK) from Formula 2 above, and the second visitor location register 106 selects the CK and IK within the selected authentication vector as its ciphering key (CK) and integrity key (IK) (operations S220 and S222). Consequently, the mobile station 100 and the second visitor location register 106 come to share the same ciphering key (CK) and integrity key (IK), and the key establishment is completed.

As described above, once authentication and key establishment are completed, the mobile station 100 and the second visitor location register 106 use the ciphering key (CK) and integrity key (IK) to begin secure communication.

However, such conventional authentication and key establishment methods may incur problems such as the following.

Firstly, the second visitor location register 106 cannot by itself authenticate the mobile station 100, but rather, can only authenticate the mobile station 100 indirectly by the use of the authentication vectors transmitted from the home location register 102.

Secondly, since the second visitor location register 106 receives a large number of authentication vectors transmitted from the home location register 102 for authentication, there may be much bandwidth wasted between the home location register 102 and the second visitor location register 106. Also, since the second visitor location register 106 stores the authentication vectors, an overhead may occur in the storage space of the second visitor location register 106.

Thirdly, no means is provided for mutual authentication between the home location register 102 and the second visitor location register 106, and between the mobile station 100 and the second visitor location register 106. In other words, no means is provided for mutual authentication in a situation where not all visitor location registers can be trusted in a mobile communication system using an extensive communication network, and therefore, when the international mobile subscriber identity data (IMSI) of the mobile station 100 is transmitted, the international mobile subscriber identity data (IMSI) can be exposed to the outside. Consequently, the privacy of the mobile station 100 can be infringed upon, that is to say, security is vulnerable.

Fourthly, since the international mobile subscriber identity data (IMSI) of the mobile station 100 is transmitted from the previous visitor location register 104 to the new visitor location register 106, in other words, since, in the process where the new visitor location register 106 identifies the mobile station 100, the previous visitor register 104—which has nothing to do with the identification—executes communications, the number of communications can increase.

### DISCLOSURE

### Technical Problem

A purpose of the present invention is to provide a communication method, especially a method for authentication and key establishment, in a mobile communication system, which enables a direct mutual authentication between a mobile station and a visitor location register and which maintains security in a stable manner.

Another purpose of the present invention is to provide a method of operating a mobile station and a visitor location register in a mobile communication system in a stable manner.

### Technical Solution

In order to fulfill the aforementioned purpose, an aspect of the present invention provides a communication method in a mobile communication system having a mobile station, a visitor location register and a home location register. This method includes: registering the mobile station with the home location register; and having the mobile station and the visitor location register directly authenticate each other and mutually share a ciphering key and an integrity when the mobile station moves to the visitor location register.

Another aspect of the present invention provides a method of operating a mobile station in a mobile communication system that includes: directly authenticating a corresponding visitor location register by using a particular random number; and sharing a ciphering key and an integrity key with the visitor location register after the authentication is completed.

Yet another aspect of the present invention provides a method of operating a visitor location register in a mobile communication system that includes: directly authenticating a corresponding mobile station; and sharing a ciphering key and an integrity key with the mobile station after the authentication is completed.

### Advantageous Effects

A communication method in a mobile communication system according to an embodiment of the present invention has the advantage of enabling direct authentication between a mobile station and a visitor location register.

Also, direct authentication is possible between the mobile station and the corresponding visitor location register, between a home location register and the visitor location register, and between visitor location registers, and as a result, there is the advantage of simplifying the authentication process. Consequently, the bandwidth consumption between the mobile station and the registers can be reduced, and the storage space of the visitor location register can also be reduced.

In addition, mutual authentication is possible between the home location register and the visitor location register, and between the visitor location registers, through the shared secret key, and since the international mobile subscriber identity data (IMSI) of the mobile station is encrypted for transmission, the international mobile subscriber identity data (IMSI) is not exposed to the outside when the mobile station transmits its international mobile subscriber identity data (IMSI). Consequently, not only is the privacy of the mobile station protected, but also the security of the mobile communication system can be maintained in a stable manner.

Furthermore, since the international mobile subscriber identity data (IMSI) of the mobile station is not transmitted from the previous visitor location register to the new visitor location register, there is the advantage of the number of communications being reduced in comparison with the technology based on the related art.

### DESCRIPTION OF DRAWINGS

FIG. 1 is a drawing illustrating a general mobile communication system.

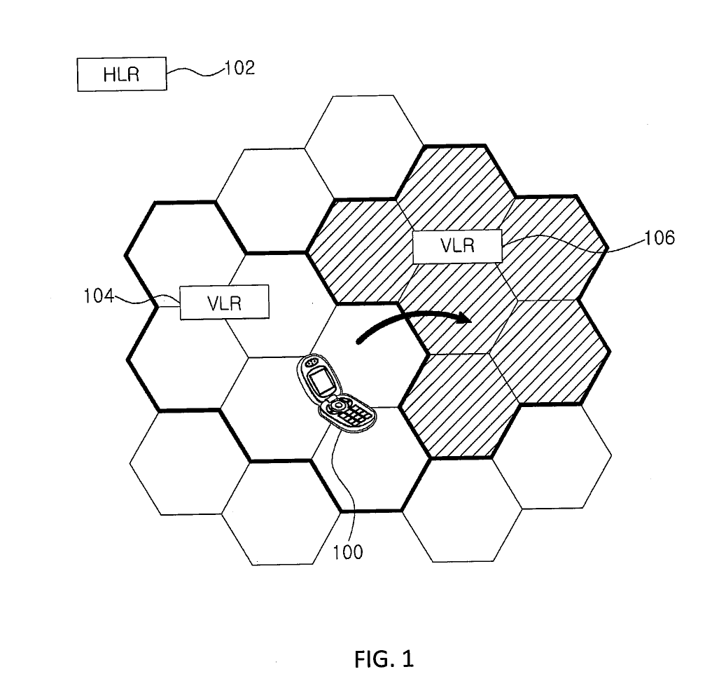

FIG. 2 is a flowchart illustrating processes of authentication and sharing the cipher key and integrity key according to the related art.

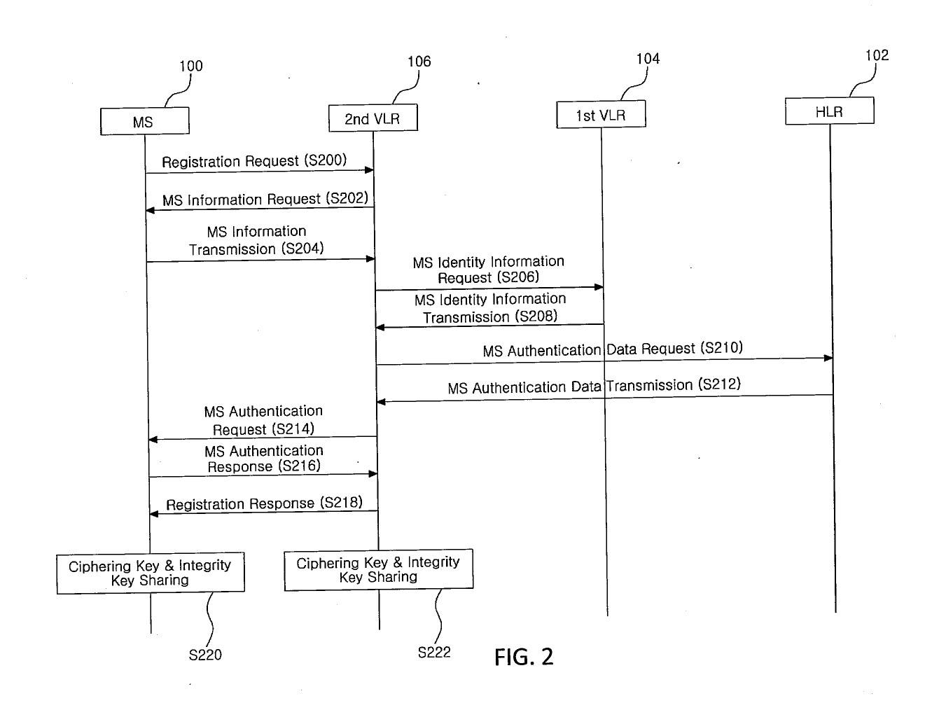

FIG. 3 is a drawing illustrating a mobile communication system according to an embodiment of the present invention.

FIG. 4 is a flowchart illustrating authentication and key establishment processes according to an embodiment of the present invention.

FIG. 5 is a flowchart illustrating in outline a VLR registration process according to an embodiment of the present invention.

FIG. 6 is a flowchart illustrating in detail a VLR registration process (authentication and key establishment process) according to an embodiment of the present invention.

### DETAILED DESCRIPTIONS

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. Those components that are the same or are in correspondence are rendered the same reference numeral regardless of the figure number.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, phases, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technological or scientific terms, have the same meanings as generally understood by those skilled in the technological field to which the present invention belongs. The terms that find other definitions in generally used dictionaries are to be interpreted as having meanings that harmonize with the related technological context, and unless otherwise clearly defined in the present patent application, are not to be interpreted as having idealistic or excessively formalistic meanings.

Below, certain embodiments of the present invention will be explained in detail with reference to the accompanying drawings.

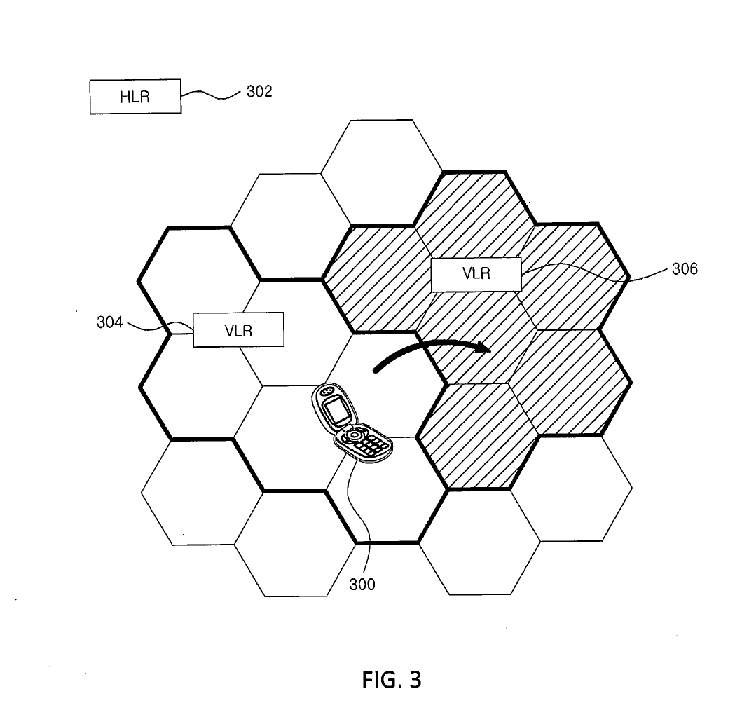

FIG. 3 is a drawing illustrating a mobile communication system according to an embodiment of the present invention.

With reference to FIG. 3, the mobile communication system according to the present embodiment is a 3GPP system, comprising a mobile station (MS) 300, a home location register (HLR) 302, and at least one visitor location register (VLR) 304 and 306.

The home location register 302 serves to store and manage information about the location and situation of the mobile station 300, and provide this information to a system requesting it. In other words, the home location register 302 is a system that guarantees the mobility of the user.

Also, the home location register 302 manages information that is required by the mobile station 300 to receive communication service, such as the mobile station's additional service information, and provides it to a system requesting it.

The visitor location registers 304 and 306 are location registers used at the mobile telephone switching center to search information for handling calls from the mobile station 300, and serve as administrators when a mobile station 300 of another jurisdiction requests service in their own jurisdictions.

The communication method, particularly the method for authentication and key establishment, in a mobile communication system according to an embodiment of the present invention involves enabling the mobile station 300 and the second visitor location register 306 to share the ciphering key and integrity key, when the mobile station 300 moves from the jurisdiction of a first visitor location register 304 to the jurisdiction of a second visitor location register 306, so as to verify the encryption/decryption and integrity within the wireless access area as they directly authenticate each other. Here, the international mobile subscriber identity data of the mobile station 300 is encrypted for transmission for security, as is described below. A detailed explanation regarding this will be given with reference to the appended illustrations.

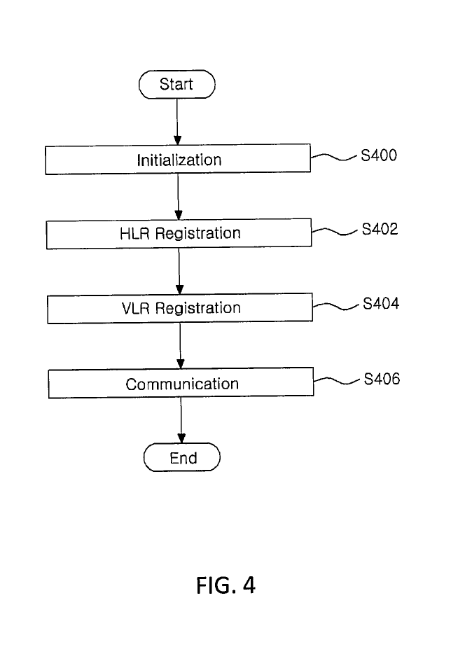

FIG. 4 is a flowchart illustrating the authentication and key establishment processes in a mobile communication system according to an embodiment of the present invention. However, it is assumed that the mobile station 300 moves from a first visitor location register 304 to a second visitor location register 306.

With reference to FIG. 4, first an initialization process is executed, initializing the mobile communication system (operation S400). The location register center (not illustrated), which manages the home location register 302 and the second visitor location register 306, selects its own secret key s₁ from a particular group Zₚ* (in other words, s₁εZₚ*), uses the selected secret key s₁ to compute the secret key K_{H} of the home location register 302 and the secret key K_{Vn} of the second visitor location register 306 as in Formula 5 below, and stores the computed secret keys K_{H} and K_{Vn} through secure methods, such as by having the user input them directly.

K_{H}=s₁H₁(ID_{H})

K_{Vn}=s₁H₁(ID_{Vn}) [Formula 5]

Here, ID_{H} is the identity information of the home location register 302, ID_{Vn} is the identity information of the second visitor location register 306, H₁: {0,1}*→G₁ is a hash function, which is a computation method that creates a pseudo random number of a fixed length in a given text, and G₁ signifies an additive group having a prime number p as its order.

Next, a HLR registration process is executed, registering the mobile station 300 with the home location register 302, so as to be provided with mobile communication service (operation S402). In more detail, the home location register 302 selects another secret key s_{2H} for itself from the particular group Zₚ* (in other words, s_{2H}εZₚ*), and uses the selected secret key s_{2H} to compute the shared key K_{HM} shared with the mobile station 300, as in Formula 6.

K_{HM}=s_{2H}H₂(IMSI) [Formula 6]

Here, IMSI is the international mobile subscriber identity data of the mobile station 300, and H₂: {0,1}*→Zₚ* is a hash function, a computing method that creates a pseudo random number of a fixed length in a given text.

As indicated in Formula 6 above, the shared key K_{HM} shared between the home location register 302 and the mobile station 300 is created by the use of the secret key s_{2H} of the home location register, and expresses the international mobile subscriber identity data (IMSI) of the mobile station 300 as a hash function H₂.

Also, the home location register 302 uses the counter chain x_{c}=H₂(x_{c+1}) as in Formula 7 below, for prevention of replay attacks and for synchronization.

$${x}_{c} = {H}_{2}^{n - c} ( {x}_{n} ) = \frac{{H}_{2} ( {H}_{2} ( … ( {H}_{2} ( {x}_{n} ) ) … ) )}{n - ctimes} \qquad [ Formula 7 ]$$

Here, c(c=0, 1, . . . , n−2, n−1) is a counter number.

As indicated in Formula 7 above, the counter chain x_{c} is expressed as a hash function, and the initial value xₙ is the international mobile subscriber identity data (IMSI) of the mobile station 300.

According to an embodiment of the present invention, the shared key K_{HM} created at the home location register 302 and the international mobile subscriber identity data (IMSI) of the mobile station 300 can be stored in the universal subscriber identity module (USIM) of the mobile station 300.

Subsequently, a VLR registration process is executed, registering the mobile station 300 with the second visitor location register 306 (operation S404). In more detail, when the mobile station 300 moves to the second visitor location register 306, the mobile station 300 and the second visitor location register 306 directly authenticate each other, and afterward, share the ciphering key and integrity key. In other words, authentication and key establishment process is executed. A more detailed explanation will be provided below with reference to the appended illustrations.

Next, the mobile station 300 and the second visitor location register 306 use the ciphering key and integrity key to execute a secure communication (operation S406).

Below, the VLR registration process (operation S404) will be described.

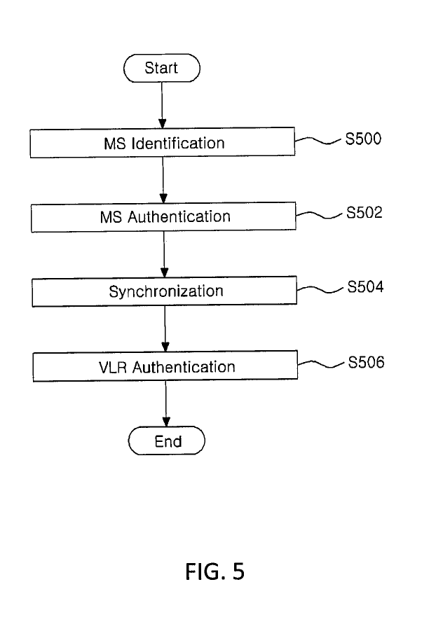

FIG. 5 is a flowchart illustrating in outline a VLR registration process according to an embodiment of the present invention.

As illustrated in FIG. 5, the VLR registration process (operation S404) comprises a MS identification operation (S500) in which the mobile station 300 is identified, a MS authentication operation (S502) in which the mobile station 300 is authenticated, a synchronization operation (S504), and a VLR authentication operation (S506).

In other words, in the VLR registration process (operation S404), an identification operation, a synchronization operation, and an authentication operation are executed.

Below, the VLR registration process 404, in particular, the authentication and key establishment processes will be described in detail with reference to the appended illustrations.

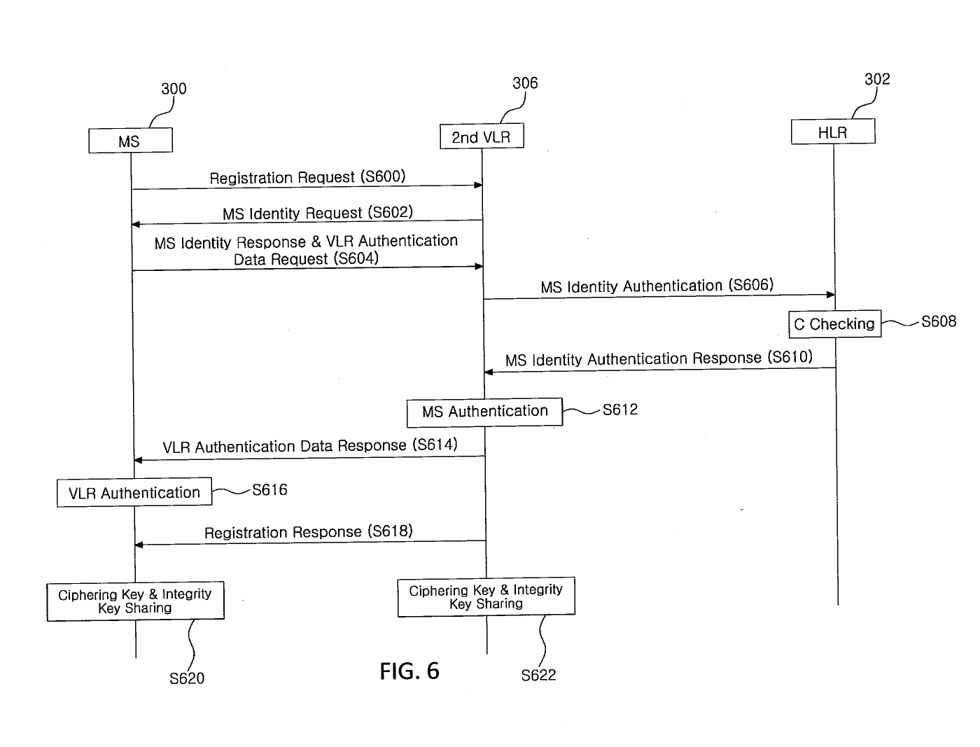

FIG. 6 is a flowchart illustrating in detail a VLR registration process (authentication and key establishment processes) according to an embodiment of the present invention. However, it is assumed that the mobile station 300 moves from the jurisdiction of the first visitor location register 304 to the jurisdiction of the second visitor location register 306.

With reference to FIG. 6, when the mobile station 300 moves into the jurisdiction of the second visitor location register 306, the mobile station 300 transmits a registration request message to the second visitor location register 306 (operation S600).

Next, the second visitor location register 306, having received the registration request message, transmits a mobile station identity information request message to the mobile station 300 (operation S602). For example, the second visitor location register 306 may select a random number n₁ from a particular group, and by transmitting the selected random number n₁ to the mobile station 300, may request the mobile station identity information.

Subsequently, the mobile station 300, in response to the request for the mobile station identity information, selects a random number n₂ from a particular group, uses the selected random number n₂ to compute the cipher value C₁ and the mobile station authentication data V₁ as in Formula 8 below, and afterward, transmits the counter chain x_{c}, the cipher value C₁, the mobile station authentication data V₁, and the identity information ID_{H} of the home location register 302 to the second visitor location register 306 (operation S604).

C₁=Eₓ_{_{c}}(IMSI∥n₂∥c)

V₁=H₂(n₁∥n₂∥C₁∥ID_{H}∥ID_{Vn}) [Formula 8]

Here, X_{c} is a hash value transmitted from the home location register 302 in the previous counter session, and E is an encryption function using the key X_{c}.

As indicated in Formula 8 above, the cipher value C₁ is a value created by encrypting (IMSI∥n₂∥c) using the key X_{c}, and the mobile station authentication data V₁ is data created by expressing the random numbers n₁ and n₂, the cipher value C₁, the identity information ID_{H} of the home location register 302, and the identity information ID_{Vn}, of the second visitor location register 306 as a hash function.

Next, out of the counter chain x_{c}, the cipher value C₁, the mobile station authentication data V₁, and the identity information ID_{H} of the home location register 302 transmitted from the mobile station 300, the second location register 306 transmits the counter chain x_{c} and the cipher value C₁ to the home location register 302, requesting the identity authentication for the mobile station (operation S606).

Subsequently, the home location register 302 computes the key X_{c} as indicated in Formula 9 below.

X_{c}=H₂(s₂_{_{H}}∥X_{c}) [Formula 9]

As indicated in Formula 9 above, the home location register 302 uses its own secret key s_{2H} and the counter chain to compute the key X_{c}.

Next, the home location register 302, by means of the computed key X_{c}, decrypts the international mobile subscriber identity data (IMSI) of the mobile station 300, the random number n₂, and the counter number c from the cipher value C₁, as in Formula 10 below.

D_{X}_{_{c}}(C₁)=IMSI∥n₂∥c [Formula 10]

Here, D is a function that uses the key X_{c} to decrypt C₁.

Subsequently, the home location register 302, in order to prevent replay attacks on the cipher value C₁, checks whether or not the counter number c is an accurate value (operation S608). If the counter number c is not an accurate value, the home location register 302 transmits a mobile station identification failure message to the mobile station 300 and to the second visitor location register 306.

Next, the home location register 302, if the counter number c is an accurate value, determines that the mobile station 300 has been identified, and afterward, creates the temporary mobile subscriber identity data (TMSIn) of the mobile station 300 and the ciphering key (CK) and integrity key (IK) between the mobile station 300 and the second visitor location register 306.

Subsequently, the home location register 302 creates the key X_{c+1} and cipher values C₂ and C₃, as in Formula 11 below.

X_{c+1}=H₂(s₂_{_{H}}∥X_{c+1})

C₂=E_{K}_{_{HVn}}_{⊕TMSIn}(CK∥IK∥n₂)

C₃=E_{K}_{_{HM}}_{⊕TMSIn}(CK∥IK∥X_{c+1}∥c+1) [Formula 11]

Here, K_{HVn} is the shared secret key used in the unicast between the home location register 302 and the second visitor location register 306, is computed as indicated in Formula 12 below, and enables mutual authentication between the home location register 302 and the second visitor location register 306.

K_{HVn}=H₂(e(K_{H},H₁(ID_{Vn}))=H₂(e(H₁(ID_{H}),H₁(ID_{V}_{ₙ})^{s}^{₁} [Formula 12]

In other words, the shared secret key K_{HVn} is expressed as a hash function and a pairing function (one that satisfies e:G₁×G₁→G₂, e(aP, bQ)=e(P, Q)^{ab}).

Next, the home location register 302 transmits the temporary mobile subscriber identity data (TMSIn) and the cipher values C₂ and C₃ of the mobile station 300 to the second visitor location register 306 (operation S610).

Subsequently, the second visitor location register 306 decrypts the ciphering key (CK), integrity key (IK) and random number n₂ from the cipher value C₂ transmitted above, as in Formula 13 below.

D_{K}_{_{HVn}}_{⊕TMSIn}(C₂)=CK∥IK∥n₂ [Formula 13]

Here, the shared secret key K_{HVn} is computed through Formula 14 below.

K_{HVn}=H₂(e(H₁(ID_{H}),K_{Vn}))=H₂(e(H₁(ID_{H}),H₁(ID_{Vn}))^{s}^{₁}) [Formula 14]

Here, the second visitor location register 306 computes the mobile station authentication data V₂ as in Formula 15 below, and checks whether or not the computed mobile station authentication data V₂ is equal to the mobile station authentication data V₁ transmitted from the mobile station 300 (operation S612).

V₂=H₂(n₁∥n₂∥C₁∥ID_{H}∥ID_{Vn}) [Formula 15]

If V₂ and V₁ are equal, the second visitor location register 306 determines that the mobile station 300 has been authenticated. On the other hand, if V₂ and V₁ are not equal, it is determined that the mobile station 300 has not been authenticated, and the second visitor location register 306 transmits a mobile station authentication failure message to the mobile station 300 and to the home location register 302, respectively.

Subsequently, if V₂ and V₁ are equal, that is to say, if the mobile station 300 is authenticated, the second visitor location register 306 computes the visitor location register authentication data V₃ as in Formula 16 below.

V₃=E_{CK⊕IK}(n₂) [Formula 16]

Next, the second visitor location register 306 transmits the cipher value C₃, the visitor location register authentication data V₃ and the temporary mobile subscriber identity data (TMSIn) of the mobile station 300 to the mobile station 300 (operation S614).

Subsequently, the mobile station 300 decrypts the ciphering key (CK), the integrity key (IK), the key X_{c+1} and the counter number c+1 from the cipher value C₃ transmitted above, as in Formula 17 below.

D_{K}_{_{HM}}_{⊕TMSIn}(C₃)=CK∥IK∥X_{c+1}∥c+1 [Formula 17]

Next, the mobile station 300 checks whether or not the counter number c+1 is an accurate value, verifying whether or not synchronization has been made.

The mobile station 300, if the counter number c+1 is an accurate value, determines that the mobile communication system has been synchronized. On the other hand, if the counter number c+1 is not an accurate value, the mobile station 300 transmits a synchronization failure message to the second visitor location register 306 and the home location register 302.

Subsequently, if synchronized, the mobile station 300 decrypts the random number n₂ from the visitor location register authentication data V₃, as in Formula 18 below.

D_{CK⊕IK}(V₃)=n₂ [Formula 18]

The mobile station 300 checks whether or not the random number n₂ computed above is equal to the random number n₂ that it selected, verifying whether or not the second visitor location register 306 has been authenticated (operation S616).

If the random number n₂ computed above is equal to the random number n₂ that it selected, the mobile station 300 determines that the second visitor location register 306 has been authenticated. On the other hand, if the random number n₂ computed above is not equal to the random number n₂ that it selected, the mobile station 300 transmits a visitor location register authentication failure message to the second visitor location register 306 and the home location register 302.

Next, if the visitor location register authentication failure message is not transmitted within the time allowed, the second visitor location register 306 transmits a mobile station registration completion message to the mobile station 300, completing the authentication and key establishment.

Subsequently, once the authentication and key establishment are completed, the mobile station 300 and the second visitor location register 306 share the ciphering key (CK) and integrity key (IK) (operations S620 and S622). Here, the mobile station 300 decrypts the cipher value C₃ through Formula 16, acquiring the ciphering key (CK) and integrity key (IK), and the second visitor location register 306 decrypts the cipher value C₂ through Formula 13, acquiring the ciphering key (CK) and integrity key (IK). Consequently, the mobile station 300 and the second visitor location register 306 come to share the same ciphering key (CK) and integrity key (IK).

Next, the mobile station 300 and the second visitor location register 306 use the ciphering key (CK) and integrity key (IK) to begin a secure communication.

In short, in the method for authentication and key establishment according to an embodiment of the present invention, a direct mutual authentication is possible between the mobile station 300 and the second visitor location register 306, and between the home location register 302 and the second visitor location register 306.

Above, the mobile communication system according to an embodiment of the present invention was treated as a 3GPP system, but its application is not limited to a 3GPP system and can be modified in various ways.

Below, a comparison will be made between a method for authentication and key establishment in a mobile communication system according to an embodiment of the present invention and a method for authentication and key establishment in a mobile communication system according to the related art.

Firstly, in the method for authentication and key establishment according to the related art, a visitor location register cannot by itself authenticate the mobile station, but rather, authenticates the mobile station indirectly through authentication vectors transmitted from the home location register. However, in the method for authentication and key establishment according to an embodiment of the present invention, since direct mutual authentication is possible between the mobile station 300 and the second visitor location register 306, between the home location register 302 and the second visitor location register 306, and between visitor location registers 304 and 306, the authentication process can be simplified.

Secondly, in the method for authentication and key establishment according to the related art, since a visitor location register receives a large number of authentication vectors from the home location register, much wasting of bandwidth occurs between the home location register and the visitor location register. Also, since the visitor location register stores the authentication vectors, a storage space overhead can occur. However, in the method for authentication and key establishment according to an embodiment of the present invention, since mutual authentication is possible between the mobile station 300 and the second visitor location register 306, and between the home location register 302 and the second visitor location register 306, bandwidth consumption between the mobile statin 300 and registers 302 and 306 can be reduced, and the necessary storage space of the second visitor location register 306 is reduced, preventing an overhead.

Thirdly, the method for authentication and key establishment according to the related art does not provide a means for mutual authentication between the home location register and a visitor location register, and between visitor location registers. In other words, no means is provided for mutual authentication in a situation where not all visitor location registers can be trusted in a mobile communication system using an extensive communication network, and therefore, when the international mobile subscriber identity data (IMSI) of the mobile station 100 is transmitted, the international mobile subscriber identity data (IMSI) can be exposed to the outside. Consequently, the privacy of the mobile station 100 can be infringed upon, that is to say, security is vulnerable. However, in the method for authentication and key establishment according to an embodiment of the present invention, mutual authentication is possible key between the home location register 302 and the second visitor location register 306, and between visitor location registers 304 and 306 by means of the shared key, and since the international mobile subscriber identity data (IMSI) of the mobile station 300 is encrypted for transmission, the international mobile subscriber identity data (IMSI) of the mobile station 300 can be prevented from exposure to the outside during transmission. In other words, security of the mobile communication system can be maintained in a stable manner.

Fourthly, in the method for authentication and key establishment according to the related art, the international mobile subscriber identity of the mobile station is transmitted from the previous visitor location register to the new visitor location register, but in the method for authentication and key establishment according to an embodiment of the present invention, the international mobile subscriber identity data (IMSI) of the mobile station 300 is not transmitted from the previous visitor location register 304 to the new visitor location register 306. Thus, in the method for authentication and key establishment according to an embodiment of the present invention, the number of communications can be reduced.

Thus, the communication method in a mobile communication system according to an embodiment of the present invention can have various applications for commercial purposes and military purposes, which require a high degree of security, having various economic and commercial effects.

### INDUSTRIAL APPLICABILITY

The aforementioned embodiments of the present invention are for illustrative purposes only and do not limit the invention, and it is to be appreciated that various changes, modifications and additions may be made by those skilled in the art without departing from the spirit and scope of the present invention, as defined by the appended claims and their equivalents.

1. A communication method in a mobile communication system having a mobile station, a visitor location register and a home location register, the method comprising:
registering the mobile station with the home location register; and
having the mobile station and the visitor location register directly authenticate each other and mutually share a ciphering key and an integrity when the mobile station moves to the visitor location register.

2. The communication method in a mobile communication system according to claim 1, the method further comprising:
an initialization operation of having a location register center use its secret key to create secret keys for the home location register and the visitor location register.

3. The communication method in a mobile communication system according to claim 1, wherein registering the mobile station with the home location register comprises:
having the home location register use its secret key to create a shared key shared with the mobile station,
and wherein the home location register uses a counter chain x_{c}, the counter chain x_{c} expressed as
$${x}_{c} = {H}_{2}^{n - c} ( {x}_{n} ) = \frac{{H}_{2} ( {H}_{2} ( … ( {H}_{2} ( {x}_{n} ) ) … ) )}{n - ctimes} ,$$
with an initial value xₙ being an international mobile subscriber identity of the mobile station.

4. The communication method in a mobile communication system according to claim 1, wherein having the mobile station and the visitor location register directly authenticate each other and mutually share a ciphering key and an integrity comprises:
identifying the mobile station;
authenticating the mobile station;
determining synchronization;
authenticating the visitor location register; and
having the ciphering key and the integrity key mutually shared.

5. The communication method in a mobile communication system according to claim 4, wherein identifying the mobile station comprises:
having the mobile station transmit a registration request message to the visitor location register;
having the visitor location register select a first random number in response to the registration request message and transmit the first random number thus selected to the mobile station to request mobile station identity information;
having the mobile station select a second random number in response to the mobile station identity information request and compute a cipher value C₁ and mobile station authentication data V₁ using the second random number thus selected;
having the mobile station transmit a counter chain x_{c}, the cipher value C₁, the mobile station authentication data V₁, and identity information ID_{H} of the home location register to the visitor location register;
having the visitor location register transmit the counter chain x_{c} and the cipher value C₁ to the home location register to request mobile station identity authentication;
having the home location register decrypt an international mobile subscriber identity data (IMSI), the second random number n₂, and a counter number c of the mobile station from the cipher value C₁; and
having the home location register verify synchronization by checking whether or not the decrypted counter number c is an accurate value,
and wherein
C₁=Eₓ_{_{c}}(IMSI∥n₂∥c)
V₁=H₂(n₁∥n₂∥C₁∥ID_{H}∥ID_{Vn})
where X_{c} is a hash value transmitted from the home location register in a previous counter session, E is an encryption function using the key X_{c}, ID_{H} is the identity information of the home location register, and ID_{Vn} is identity information of the visitor location register.

6. The communication method in a mobile communication system according to either claim 4 or claim 5, wherein authenticating the mobile station comprises:
having the home location register create a temporary mobile subscriber identity data (TMSIn) of the mobile station and the ciphering key (CK) and integrity key (IK) between the mobile station and the visitor location register, if the counter number c is an accurate value;
having the home location register create cipher values C₂ and C₃ using the ciphering key (CK) and the integrity key (IK);
having the home location register transmit the temporary mobile subscriber identity data (TMSIn) of the mobile station and the cipher values C₂ and C₃ to the visitor location register;
having the visitor location register decrypt the ciphering key (CK), the integrity key (IK), and a random number n₂ from the transmitted cipher value C₂;
having the visitor location register compute a mobile station authentication data V₂; and
having the visitor location register authenticate the mobile station by verifying whether or not the computed mobile station authentication data V₂ is equal to a mobile station authentication data V₁ transmitted from the mobile station,
and wherein
V₂=H₂(n₁∥n₂∥C₁∥ID_{H}∥ID_{Vn}).

7. The communication method in a mobile communication system according to claim 6, wherein determining synchronization comprises:
having the visitor location register create a visitor location register authentication data V₃ if the mobile station is authenticated;
having the visitor location register transmit the cipher value C₃, the visitor location register authentication data V₃, and the temporary mobile subscriber identity data (TMSIn) of the mobile station to the mobile station;
having the mobile station decrypt the ciphering key (CK), the integrity key (IK), a key X_{c+1} and a counter number c+1 from the transmitted cipher value C₃; and
having the mobile station determine whether or not there is synchronization by verifying the decrypted counter number c+1,
and wherein
V₃=E_{CK⊕IK}(n₂).

8. The communication method in a mobile communication system according to claim 7, wherein authenticating the visitor location register comprises:
having the mobile station decrypt the second random number n₂ from the visitor location register authentication data V₃ if it is determined that there is synchronization; and
having the mobile station authenticate the visitor location register by verifying whether or not the decrypted random number n₂ is equal to the random number n₂ selected by the mobile station.

9. A method of operating a mobile station in a mobile communication system, the method comprising:
directly authenticating a corresponding visitor location register by using a particular random number; and
sharing a ciphering key and an integrity key with the visitor location register after the authentication is completed.

10. The method of operating a mobile station in a mobile communication system according to claim 9, wherein directly authenticating the visitor location register comprises:
computing a cipher value C₁ and a mobile station authentication data V₁ by using the random number n₂;
transmitting a counter chain x_{c}, the cipher value C₁, the mobile station authentication data V₁, and identity information ID_{H} of the corresponding home location register to the visitor location register;
having the visitor location register transmit the counter chain x_{c} and the cipher value C₁ to the home location register;
having the home location register create cipher values C₂ and C₃ by using the ciphering key (CK) and the integrity key (IK);
having the home location register transmit the cipher values C₂ and C₃ to the visitor location register;
having the visitor location register decrypt the ciphering key (CK), the integrity key (IK), and the random number from the transmitted cipher value C₂;
having the visitor location register compute a visitor location register authentication data V₃;
receiving the visitor location register authentication data V₃ from the visitor location register;
decrypting the random number from the visitor location register authentication data V₃; and
authenticating the visitor location register by verifying whether or not the decrypted random number is equal to the random number n₂ that was selected,
and wherein
C₁=Eₓ_{_{c}}(IMSI∥n₂∥c)
C₂=E_{K}_{_{HVn}}_{⊕TMSIn}(CK∥IK∥n₂)
C₃=E_{K}_{_{HM}}_{⊕TMSIn}(CK∥IK∥X_{c+1}∥c+1)
V₃=E_{CK⊕IK}(n₂)
where TMSIn is a temporary mobile subscriber identity data of the mobile station, IMSI is an international mobile subscriber identity data of the mobile station, and X_{c+1} and C+1 represent a key and a counter number, respectively.

11. The method of operating a mobile station in a mobile communication system according to claim 9, the method further comprising: determining synchronization,
wherein the determining of synchronization comprises:
receiving the cipher value C₃, the visitor location register authentication data V₃, and the temporary mobile subscriber identity data (TMSIn) of the mobile station from the visitor location register;
decrypting the ciphering key (CK), the integrity key (IK), a key X_{c+1}, and a counter number c+1 from the transmitted cipher value C₃; and
determining whether or not there is synchronization through the decrypted counter number c+1.

12. A method of operating a visitor location register in a mobile communication system, the method comprising:
directly authenticating a corresponding mobile station; and
sharing a ciphering key and an integrity key with the mobile station after the authentication is completed.

13. The method of operating a visitor location register in a mobile communication system according to claim 12, wherein directly authenticating the mobile station comprises:
receiving a counter chain x_{c}, a cipher value C₁, a mobile station authentication data V₁, and identity information ID_{H} of the home location register from the mobile station;
computing a mobile station authentication data V₂; and
authenticating the mobile station by verifying whether or not the computed mobile station authentication data V₂ is equal to the mobile station authentication data V₁ transmitted from the mobile station,
and wherein
C₁=Eₓ_{_{c}}(IMSI∥n₂∥c)
V₁=H₂(n₁∥n₂∥C₁∥ID_{H}∥ID_{Vn})
V₂=H₂(n₁∥n₂∥C₁∥ID_{H}∥ID_{Vn}).
where IMSI is an international mobile subscriber identity data of the mobile station, n₁ is a random number selected by the visitor location register, n₂ is a random number selected by the mobile station, X_{c} is a hash value transmitted from the home location register in a previous counter session, E is an encryption function using the key X_{c}, ID_{H} is the identity information of the home location register, and ID_{Vn}, is identity information of the visitor location register.
